(19) United States
(12) Patent Application Publication
(10) Pub. No.: US 2013/0311312 A1
(43) Pub. Date: Nov. 21, 2013

(54) Method for transferring money

(71) Applicant: Aaron Mendlowitz, Cedarhurst, NY (US)

(72) Inventor: Aaron Mendlowitz, Cedarhurst, NY (US)

(21) Appl. No.: 13/473,803

(22) Filed: May 17, 2012

(51) Int. Cl. G06Q 20/20; G06Q 20/10

(52) U.S. Cl. 705/16; 705/39; 705/44

(57) ABSTRACT

The present invention is a system and method for transmitting money from a payor to a payee, whereby the payee requests payment based on a unique identifier, said system sends an electronic authorization requests to a payor, said payor authorizes said request, and money is transferred to the payee, whereby said system does not transmit information relating to specific bank or credit card accounts of the payor.

### BACKGROUND OF THE INVENTION

Electronic commerce has led to both consumer demand for methods of exchanging money along with an increased concern for secure transactions.

Payment systems such as PayPal, Google wallet, and RFIP payment cards have become very popular. Unfortunately, there are many documented cases of theft resulting in use of these systems.

There exists a need for the electronic transfer of money while maintaining high standards of security.

### SUMMARY OF THE INVENTION

In one embodiment, the present invention is a method for transferring money, said method comprising:

providing a payee with a electronic payment acceptance platform;

providing secure access to said payment acceptance platform;

accessing said payment acceptance platform;

requesting payment from said payment acceptance platform;

transmitting said requested payment electronically to a system for payment fulfillment;

providing a payor with an electronic payment transfer platform;

providing access to said payment transfer platform;

receiving a request from said system for transfer of money;

providing secure confirmation of said request from said system for transfer of money;

transmitting said confirmation of request from said system for transfer of money to said system;

providing confirmation to said payee that said request is confirmed.

The payee can be a merchant accessing the system/payment acceptance platform at a point of sale.

The payment acceptance platform is operatively associated with a payee account and a payor account. The payment acceptance platform is accessed with a secure login access and is operatively associated with a computer program stored on a non-transitory medium, said program associates an identifying number with a payor and at least one pre selected payor account for transmitting money. In one embodiment, the identifying number is a customer number, telephone number and the like.

There is at least one pre selected payor account operatively associated with said program for transmitting money. This account can be a bank account, credit card account, line of credit, or combinations thereof.

The system request for authorization is sent to a payor by at least one of email, SMS, MMS, Internet message, telephone, or combinations thereof. It is contemplated the transmission of the authorization request take place quickly so as to facilitate transfer of money at a point of sale.

The system secure confirmation includes at least one of alpha numeric identifier, biometric identifier, or combinations thereof, wherein said confirmation is operatively associated with said payor account prior to use.

Once approval is authorized, the system accesses the payor account and transfers money to a payee.

Also contemplated in the present invention is a system for transferring money comprising:

a program stored on a non-transitory computer readable medium, said program having stored thereon: identification information of pre registered payors and payees; and secure access information unique for and operatively associated with each individual payor and payee;

communications means for receiving an electronic request for payment from a payee identifying a unique payor;

communications means for sending an electronic request for authorization to said unique payor specified by said electronic request for payment from said payee;

receiving means for receiving said unique access information from said unique payor, said unique access information configured to notify said system that said electronic request for payment from a payee identifying a unique payor is approved for payment;

transmitting means whereby said system transmits acceptance of said transaction to said payee sending said electronic request for payment;

financial transmission of said amount in said request for payment from a pre registered payor account to a pre registered payee account.

### DETAILED DESCRIPTION OF THE INVENTION

As understood herein, the present invention relates to a novel process by which payments are made. Although reference is made here to a merchant, the invention, in its broadest sense, relates to transfer of money between a payor and payee.

It is not necessary that the payee be a “merchant” in the strict meaning of the word.

In a preferred embodiment, a merchant will sign up for the payment service. The merchant will be able to access the payment system through conventional credit card processing machines. The system provides an added protection for the consumer because the actual credit card number is not being transmitted in the present invention.

The business will sign up with a business name, user name and password. The business will enter a price and will enter a telephone number associated with a consumer. A database is accessed whereby the telephone number is operatively associated with a payor method of payment. This is any method of payment and includes, but is not limited to, credit card, bank account, line of credit, combinations thereof and the like.

At the point of sale, the telephone number will be presented and the payee or merchant will be linked to a database whereby a payment will be associated with the telephone number. At the point of sale the merchant receiving payment will access the system and communicate to a purchaser.

The purchaser will have an account with the system and that account will be linked to a method of payment and a method of communicating a payment request. At the point of sale, in a preferred embodiment, a message will be sent to the purchaser. The message can be any one of a text message, a telephone call, an email message, or combinations thereof. The purchaser will see a transaction amount and a request for payment. The purchaser at this time will authorize the transaction and payment will be transmitted to the merchant. In one embodiment, the payor will dial a telephone number and the payment platform is accessed by telephone. This is an improvement over current payment methods in that the consumer is not transmitting actual credit card or bank account information. Further, the merchant does not need any particular security infrastructure to protect and secure consumer banking and/or credit card information. The consumer is merely authorizing access to a preselected method of payment based on a telephone number. The lack of transmission of an actual credit card or bank account number will assist in security of a consumer payment account. Additionally, no actual credit card or account number is stored with the payor. Thus, if the payor is using a telephone or smartphone to authorize payment, the authorization is through a payment fulfillment platform. Thus, if the phone is stolen or otherwise compromised, the any accountant information cannot be retrieved from the actual phone.

In a preferred embodiment the software utilized by the merchant at the point of sale is constructed with an application programmer interface (API) which facilitates communication using the system and method of the present invention. It is further contemplated in the system and method of the present invention that the payment card industry (PCI) standards of compliance are in fact incorporated into the present invention. This would include, but not be limited to, utilizing using a single sign on (SSO) log-in whereby a user name, pass code, and/or application code would need to be present in order for a merchant to access the system. By utilizing these varying measures of security, spoofing, security breaches, and other unauthorized transactions are prevented and the present method is an improvement over radio frequency payment systems that are suspect to intercept by radio frequency receivers. As an example, for illustrative purposes only, a security breach to a PayPal account allows the perpetrator the opportunity to send money. In the system of the present invention, a request for payment will require a real time authorization from a registered payor.

In one embodiment of the present invention a merchant can access the system by using a mobile device such as a smart phone, smart pad, computer terminal, and the like, a point of sale access integrated with such software as Paypal or via direct website access.

In an embodiment involving PayPal, a request is sent, via the system of the present invention to authorize payment to a particular PayPal account.

IN one embodiment regarding use of the system and method of the present invention, the merchant will enter the price at the point of sale and a phone number. The merchant will not have access to the form of payment. That is to say, the merchant does not have actual account information. The phone number associated with the transaction will trigger a communication to an end user (i.e. a payor). The end user will review the request for payment and provide immediate authorization or lack thereof.

When the user authorizes the transaction, the merchant is immediately notified via the system of the present invention. The merchant will have an account whereby settlement occurs and merchant is paid in a desired manner. The desired manner in one embodiment is direct transfer to a merchant bank account. The present invention represents a significant improvement over systems such as Google wallet and Paypal. This is because in systems such as Paypal, if a user's Paypal account is somehow breached, the breaching party has complete unfettered access to the account payment information and can withdraw funds or send funds at will.

Regarding Google Wallet, radio frequency transmission is subject to interception by radio frequency receiving devices designed for such a purpose. In these cases, if security is breached, the breaching party will again have unfettered access to the financial payment means selected by the consumer.

The present invention has addressed this in that no payment can be made until the communication is transmitted requesting payment and the consumer enters an acceptance for that payment. It is further contemplated that the acceptance be coupled with an acceptance password or an acceptance code. In the embodiment involving an acceptance code, a user receiving a message via text message or telephone call will not only have an opportunity to accept the charge, but will also enter either a numeric or alphanumeric code associated with the acceptance. In this embodiment there is an additional level of security because there is no access to the consumer's financial information and it is inaccessible even in the unlikely event that the system security features are breached.

In one embodiment, a payor accesses the system using a smartphone application configured for these transactions. However, the app is configured only to access the payment platform and not to actually have or store account numbers for payment.

In an app format, the payor can set preferences such that a transaction is initiated to a selected merchant from a list of merchants based on user set criteria. The user set criteria includes, but is not limited to, direct user input, past purchase to a merchant, and past requests from payment from a merchant. The merchant list can further be populated based on QR code info and the like.

The present invention, in one embodiment, is a web site widget for payment in which a phone number or other identifying indicia is transmitted in order to access the payor fulfillment platform.

It is further contemplated in the present invention, that when a consumer sets up their own payment account, the payment account information available on their account setup on the internet additionally has limited access coupled with security access information. Currently, with systems like Paypal, when a user logs on to their own account they have the ability to send money directly from their Paypal account screen. The present invention will not allow this. The present invention will only allow for the transmittal of funds based on the steps including a merchant request, whereby said merchant has preregistered for access to the system of the present invention, followed by transmittal to a consumer, and authorized by a preselected consumer authorization means. In this manner, the layers of security protect the consumer financial transaction from fraudulent use.

The invention includes a system with a computer program stored on a non-transitory physical medium operatively associate with a requesting means. The requesting means, in one embodiment, is a pre-registered payee that will query the system and request a payment based on an identification number. In one embodiment, the identification number is a telephone number.

The system will then query a database and associate the identification number with a verification means. The verification means is any of email, SMS, MMS, telephone call, combinations thereof, and the like. The verification means will then notify a payor that a request for payment has been made. The payor will have a verification confirmation means to inform the system that the transaction is authorized. Once authorization is received in the system, the system will notify the payor and initiate payment based on the payor payment preference stored in the system.

In one embodiment, the invention is a method for making payment at a point of purchase consisting essentially of:

accessing an electronic payment request platform whereby a seller requests payment;

receiving a payment fulfillment request in a payor platform; associating at least one funding source a phone number operatively associated with said payor platform;

authorizing payment to said payor platform by entering said phone number, whereby said entering of said phone number actuates said payor platform, transfers money to said electronic payment request platform, and notifies said seller of said payment transfer.

Although the invention has been described with reference to specific embodiments and drawings, it is to be understood that the invention is not limited to those precise embodiments, and that various changes and modifications may be effected by one skilled in the art without departing from the scope or spirit of the present invention.

I claim:

1. A method for transferring money, said method comprising:
providing a payee with an electronic payment acceptance platform;
providing secure access to said payment acceptance platform;
accessing said payment acceptance platform;
requesting payment from said payment acceptance platform;
transmitting said requested payment electronically to a system for payment fulfillment;
providing a payor with an electronic payment transfer platform;
providing secure access to said payment transfer platform;
receiving a request from said system for transfer of money;
providing secure confirmation of said request from said system for transfer of money;
transmitting said confirmation of request from said system for transfer of money to said system;
providing confirmation to said payee that said request is confirmed.

2. The method of claim 1 where said payee is a merchant.

3. The method of claim 1 where said payment acceptance platform is at a point of sale.

4. The method of claim 1 where said payment acceptance platform is operatively associated with a payee account.

5. The method of claim 1 where said payment acceptance platform is accessed with a secure login access.

6. The method of claim 1 where said system is operatively associated with a computer program stored on a non-transitory medium, said program associates an identifying number with a payor and at least one pre selected payor account for transmitting money.

7. The method of claim 7 wherein said at least one pre selected payor account for transmitting money is a bank account, credit card account, line of credit, or combinations thereof.

8. The method of claim 7 wherein said system request for authorization is sent to a payor by at least one of email, SMS, MMS, Internet message, telephone, or combinations thereof.

9. The method of claim 1 wherein said providing secure confirmation includes at least one of alpha numeric identifier, biometric identifier, or combinations thereof, wherein said confirmation is operatively associated with said payor account prior to use.

10. A system for transferring money comprising:
a program stored on a non-transitory computer readable medium, said program having stored thereon: identification information of pre registered payors and payees; and secure access information unique for and operatively associated with each individual payor and payee;
communications means for receiving an electronic request for payment from a payee identifying a unique payor;
communications means for sending an electronic request for authorization to said unique payor specified by said electronic request for payment from said payee;
receiving means for receiving said unique access information from said unique payor, said unique access information configured to notify said system that said electronic request for payment from a payee identifying a unique payor is approved for payment;
transmitting means whereby said system transmits acceptance of said transaction to said payee sending said electronic request for payment;
financial transmission of said amount in said request for payment from a pre registered payor account to a pre registered payee account.

11. A method for making payment at a point of purchase consisting essentially of:
accessing an electronic payment request platform whereby a seller requests payment;
receiving a payment fulfillment request in a payor platform;
associating at least one funding source a phone number operatively associated with said payor platform;
authorizing payment to said payor platform by entering said phone number, whereby said entering of said phone number actuates said payor platform, transfers money to said electronic payment request platform, and notifies said seller of said payment transfer.
